(19) United States
(12) Patent Application Publication
(10) Pub. No.: US 2007/0049128 A1
(43) Pub. Date: Mar. 1, 2007

(54) Mounting structure

(76) Inventor: Paul Brassard, Arcadia, CA (US)

Correspondence Address: JAMES E. BRUNTON, ESQ., P. O. BOX 29000, GLENDALE, CA, 91209, US

(21) Appl. No.: 11/216,309

(22) Filed: Aug. 30, 2005

(51) Int. Cl. H01R 13/502

(52) U.S. Cl. 439/686

(57) ABSTRACT

An improved mounting structure for mounting objects, such as handheld electronic devices within a vehicle. The improved mounting structure includes a novel mounting plate that is provided with a pair of spaced-apart, uniquely-shaped connector elements that can be securely mated with connector elements provided on an object connector plate to which the handheld electronic device is connected.

### BACKGROUND OF THE INVENTION

### FIELD OF THE INVENTION

The present invention relates generally to mounting structures for supporting articles especially within vehicles. More particularly the invention concerns an improved mounting structure for mounting electronic devices which comprises a mounting plate having a pair of uniquely configured, spaced-apart connector elements that are designed to be used in interconnecting a selected object connector plate with the improved mounting structure.

### SUMMARY OF THE INVENTION

It is an object of the present invention to provide an improved mounting structure for mounting objects, such as PDAs, Palm devices, and like electronic components within a vehicle. More particularly it is an object of the invention to provide such a mounting structure which includes a uniquely designed mounting plate that can be used in interconnecting an object connector plate with the improved mounting structure.

Another object of the invention is to provide an improved mounting structure of the aforementioned character in which the mounting plate is provided with a pair of spaced-apart, uniquely-shaped connector elements that can be securely mated with connector elements provided on the object connector plate.

Another object of the invention is to provide an improved mounting structure of the character described in the preceding paragraphs in which the improved mounting plate provides a more secure fit with the object connector plate than was possible with prior art constructions.

Another object of the invention is to provide an improved mounting structure of the class described in which the improved mounting plate provides a reliable, robust interconnection between the mounting plate and the object connector plate to which the object to be mounted is secured.

Another object of the invention is to provide an improved mounting structure of the character described in which the improved mounting plate is provided with uniquely designed connector elements that snugly receive connector elements on the object connector plate so that play between the object connector plate in the improved mounting structure is minimized.

Another object of the invention is to provide an improved mounting structure which includes novel release means for releasing the suction on the suction-type connector of the mounting structure.

Another object of the invention is to provide an improved mounting structure as described in the preceding paragraphs which is specially designed to substantially reduce road vibration.

Another object of the invention is to provide an improved mounting structure that is compact, easy to use and is economical to manufacture in large quantities.

### BRIEF DESCRIPTION OF THE DRAWINGS

FIG. 1 is a generally perspective top view of one form of the improved mounting structure of the present invention.

FIG. 1A is a generally perspective view of a prior art mounting structure, several features of which have been modified and improved in the improved mounting structure of the present invention.

FIG. 2 is a generally perspective bottom view of the improved mounting structure shown in FIG. 1.

FIG. 3 is a generally perspective, exploded view of the improved mounting structure shown in FIGS. 1 and 2 of the drawings.

FIG. 4 is a longitudinal, cross-sectional view of the improved mounting structure shown in FIGS. 1 and 2.

FIG. 4A is a generally perspective, exploded view of one form of the mounting plate and object connector plate of the invention, the mounting plate being partly broken away to showing internal construction.

FIG. 4B is an exploded, side-elevational view of the mounting plate and object connector plate shown in FIG. 4A, the object connector plate being partially broken away to show internal construction.

FIG. 4C is a generally perspective view of the mounting plate and object connector plate shown in FIG. 4A as the components appear when in the position to be moved into an interlocking configuration.

FIG. 4D is a cross-sectional view taken along lines 4D-4D of FIG. 4C.

FIG. 4E is a generally perspective, diagrammatic view, similar to FIG. 4C illustrating movement of the mounting plate and connector plate into an interlocking configuration.

FIG. 4F is a cross-sectional view taken along lines 4F-4F of FIG. 4E showing the mounting plate and connector plate in an interconnected configuration.

FIG. 5 is a generally perspective top view, similar to that shown in FIG. 1, but showing one form of the object connector plate interconnected with the mounting plate.

FIG. 6 is a generally perspective top view, similar to that shown in FIG. 1, but showing an alternate form of the object connector plate of the invention interconnected with the mounting plate of the improved mounting structure.

### DESCRIPTION OF THE INVENTION

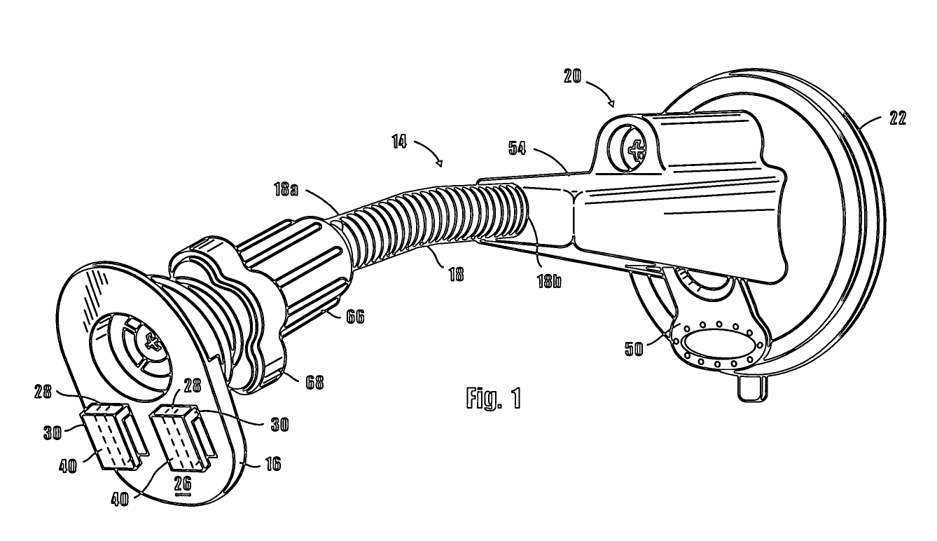

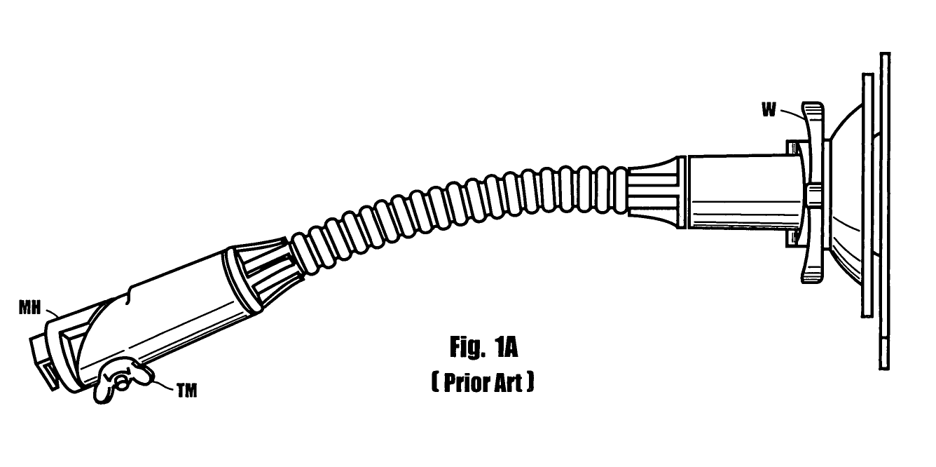

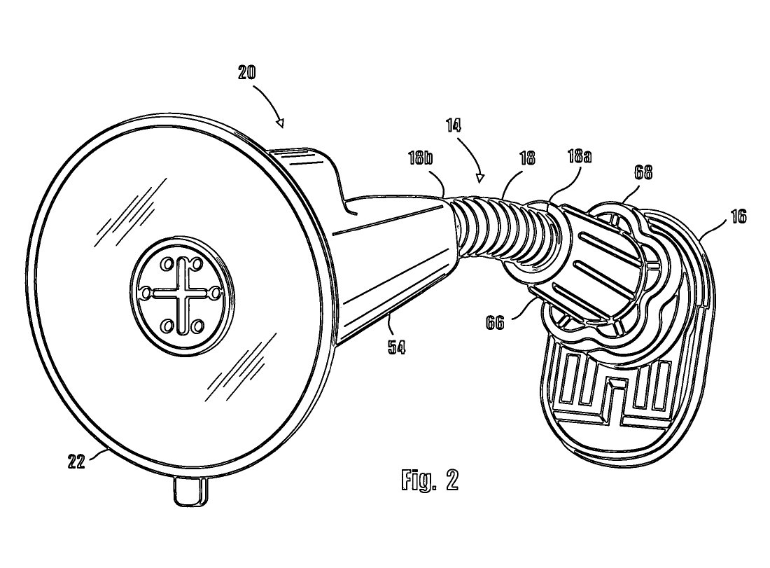

Referring to the drawings and particularly to FIGS. 1, 2 and 3, one form of the improved mounting structure of the present invention for use with a selected object connector plate is there illustrated and generally designated by the number 14. One of the improvements of the improved mounting structure over prior art devices, such as that illustrated in FIG. 1A of the drawings, resides in construction of the improved mounting plate 16 of the structure to which a selected object connector plate is interconnected to form the object mounting structure of the invention. The details of construction of this improved mounting structure will presently be described.

As shown in FIG. 1, the improved mounting plate 16 is interconnected with the first end 18aof an elongated flexible arm 18 by connector means, the details of construction of which are best seen in FIG. 3 of the drawings. Connected at the opposite, or second end 18bof flexible arm 18 is a suction-type connection mechanism 20 that includes a suction cup component 22 that is designed to be removably attached to a smooth surface, such as the windshield of a conventional vehicle. As will presently be described, connector mechanism 20 includes a novel suction forming and release mechanism for forming and releasing suction developed by suction cup 22.

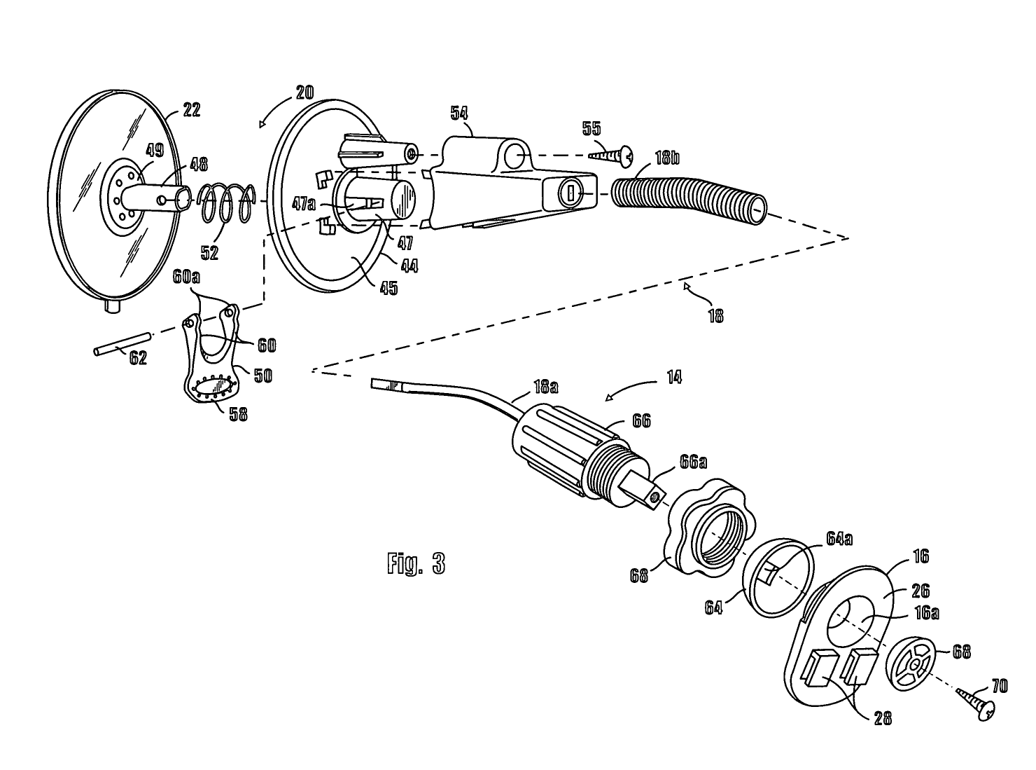

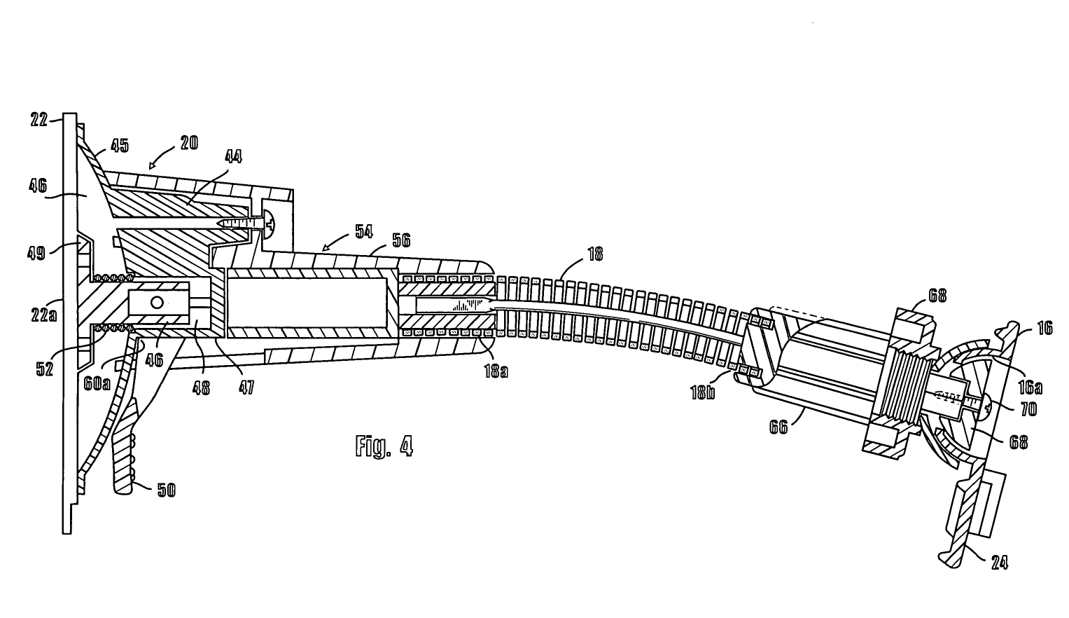

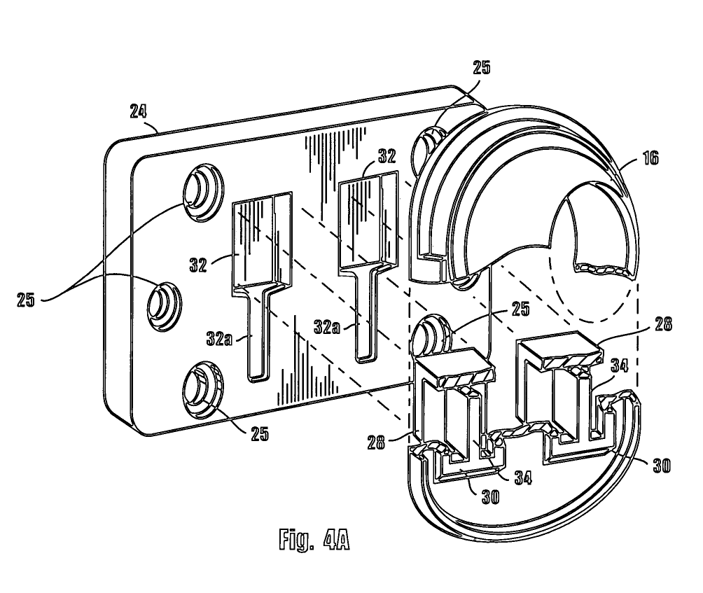

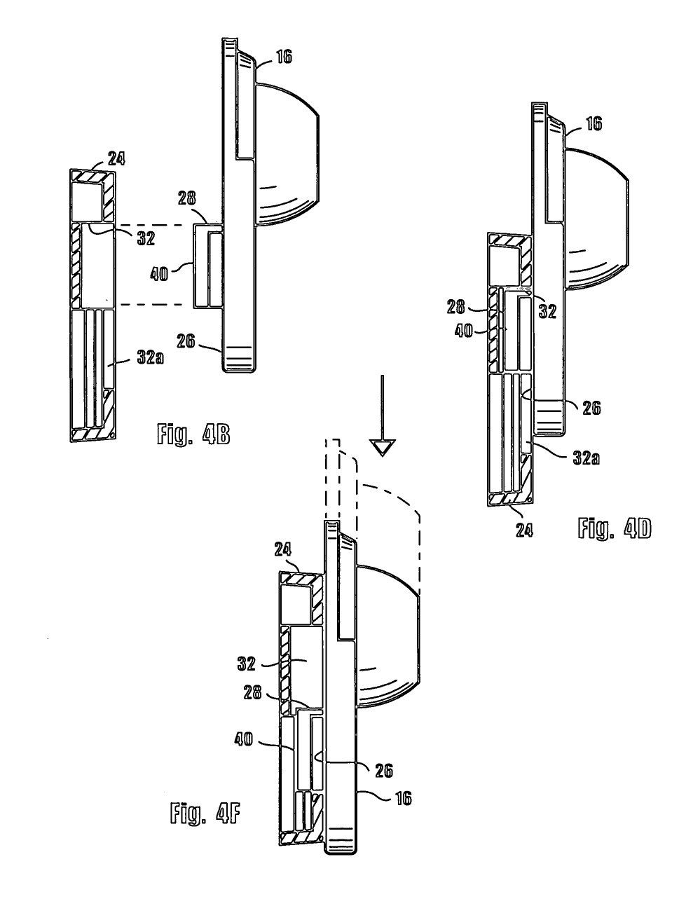

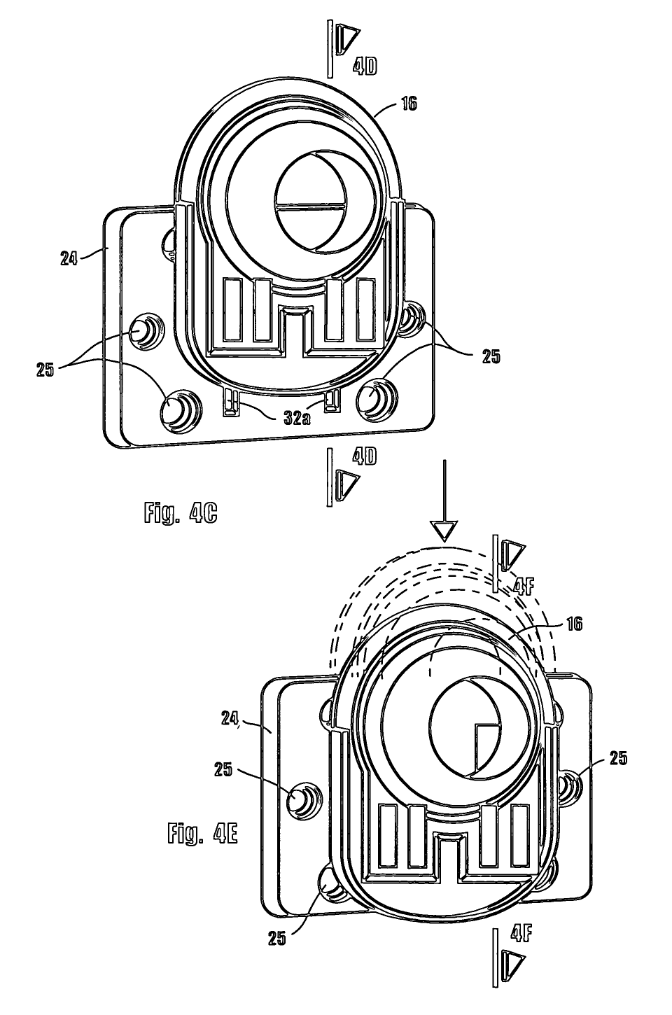

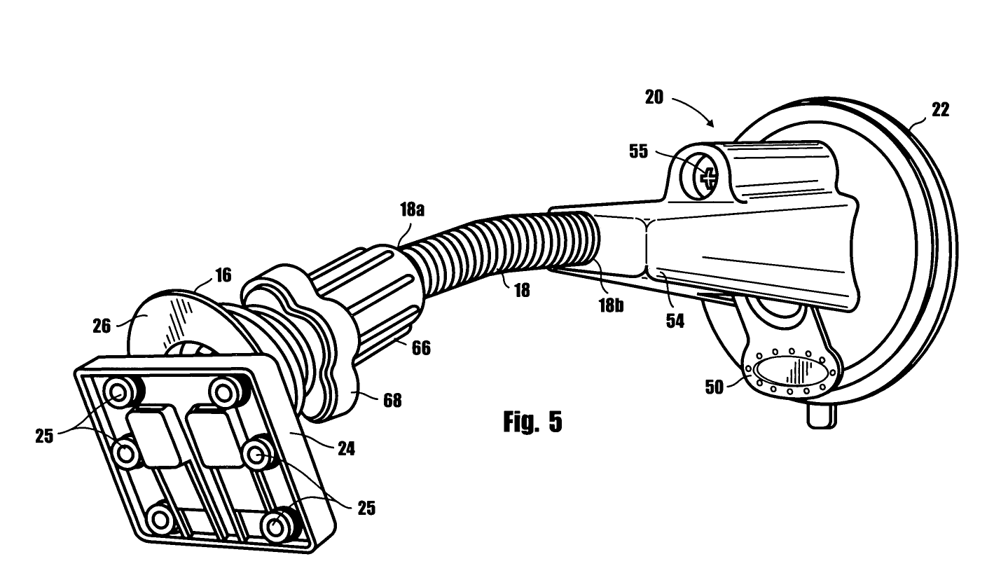

Considering now the construction of the improved mounting plate 16 and its interaction with the object connector plate 24 of the invention. As illustrated in FIGS. 1, 4A, 4B, 4C, 4D, 4E and 4F, mounting plate 16 is provided with a generally planar upper surface 26 to which a pair of uniquely configured, spaced-apart connector elements 28 are connected. As shown in FIG. 4A, each of the connector elements 28 is provided with an upstanding, generally “T”-shaped connector segment 30. “T”-shaped connector segments 30 are lockably received within spaced-apart cavities 32 formed in the article connector plate 24. Plate 24, which is illustrated in FIG. 4A, is provided with a plurality of spaced-apart apertures 25 to permit the connector plate to be interconnected with various types of cradles (not shown) for supporting articles such as, for example, cell phones, PDA's, handheld computers and like devices.

During the step of interconnecting the object connector plate 24 with the mounting plate 16, the connector plate 24 is first moved from the position shown in FIGS. 4A and 4B into the position shown in FIGS. 4C and 4D wherein the connector elements 28 of the mounting plate are moved into the upper portions the cavities 32 of the article connector plate. This done, the mounting plate is moved from the configuration shown in the dotted lines in FIGS. 4E and 4F into the position shown by the solid lines in FIGS. 4E and 4F. During this movement, the leg portions 34 of the “T”-shaped locking segments of the mounting plate will slide into the elongated slot portions 32aof the cavities 32 formed in the connector plate 24 and will be securely locked in position by the top wall portions 40 of the connector elements 30 (see FIGS. 1 and 4B). With the novel construction thus described, the uniquely designed connector elements 28 of the connector plate are snugly received within the mating cavities of the object connector plate 24 so that play between the object connector plate in the improved mounting plate is minimized. Additionally, the spaced-apart connector elements positively resist any rotational movement between the object connector plate and the mounting plate. It is these important features that are lacking in the single connector element construction of the prior art devices as exemplified by the device illustrated in FIG. 1A of the drawings.

Consider next the suction forming and release mechanism of the improved mounting structure of the present invention. Typically, in the prior art devices, suction is formed between the windshield and the suction cup portion of the suction forming mechanism by, in some way, pulling the center of the suction cup away from the windshield. When the central portion 22aof the outer surface of the suction cup body is pulled away from the windshield surface, a partial vacuum is formed causing the suction cup to adhere to the surface. The greater the vacuum the better the suction cup adheres to the windshield surface.

As previously mentioned, the apparatus of the present invention includes a suction cup 22 that is carried by an inner housing 44 (FIG. 4) having a flange portion 45. Housing 44 is provided with concave cavity 46 and an upstanding central portion 47 having an axial passageway 48 within which a drive member 48 reciprocates (FIG. 4). When a vacuum is formed by the suction forming mechanism of the invention, the central portion of suction cup 22 is received within concave cavity 46 of the inner housing. Drive member 48 is interconnected with central portion of the suction cup by a connector flange 49 in the manner shown in FIGS. 3 and 4 and is movable by a pivotally mounted lever member 50 against the urging of a biasing means from a first retracted position to the second extended position shown in FIG. 4. This biasing means is here provided in the form of a coil spring 52 which encircles drive member 46. As illustrated in FIGS. 3 and 4 of the drawings, inner housing 44 is encased within an outer housing 54 and is held in position with respect to the outer housing by a screw 55. As illustrated in FIG. 4 of the drawings, outer housing 54 is provided with a neck portion 56 that receives the lower end of flexible neck 18.

As best seen in FIG. 3, lever member 50, which is generally yoke-shaped, has a finger engaging portion 58 and a pair of spaced-apart outwardly extending arms 60, each of which includes a cam-like extremity 60athat bears against flange 45 of the inner housing 44. Arms 60 are apertured to receive a transversely extending connector pin 62, which extends through slots 47aformed in inner housing 47 and functions to interconnect lever member 50 with the drive member 46. With this construction, when the lever member is moved pivotally upwardly from the position shown in FIG. 4, the drive member 46 along with the central portion of the suction cup 22 will also move upwardly causing a suction to be formed which will hold the supporting structure securely in position on the vehicle windshield.

When it is desired to remove the supporting structure from the vehicle windshield and to break the vacuum holding it in position, a pressure exerted against the finger engaging portion 58 of lever member 50 against the urging of spring 52 will cause the lever member to pivot into the downward position shown in FIG. 4. This downward movement of lever member 50 will cause the cam-like extremities 60aof the arms 62 to bear against flange 45 in a manner to cause drive member 46 to move downwardly as shown in FIG. 4, thereby releasing the vacuum formed within the vacuum cup 22.

The uniquely constructed and easy and convenient to operate suction forming and release mechanism of the improved mounting structure of the present invention as described in the preceding paragraphs comprises a substantial improvement over the prior art suction forming and release mechanism provided on the prior art device illustrated in FIG. 1A of the drawings. More particularly, as indicated in FIG. 1A, in the prior art device there illustrated, suction forming and release is accomplished by a turn-wheel type mechanism which requires the awkward and cumbersome rotation of a rotatable, wheel-like member “W” provided near the base of the prior art device.

Another improvement of the supporting structure of the present invention over the prior art device illustrated in FIG. 1A, resides in the previously identified connector means which interconnects the mounting plate 16 with the elongated flexible arm 18. As indicated in FIG. 1A, the mounting head “MH” of the prior art device is interconnected with the elongated flexible arm by means of a compression joint that is tightened and loosened by a thumbscrew “TM”. Unlike the novel ball and socket connector means of the present invention which permits a swiveling movement of the connector plate relative to the flexible arm, the connector plate of the prior art device can only be moved along a fixed arc as a portion of the compression joint is rotated.

As best seen by referring to FIGS. 3 and 4 of the drawings, mounting plate 16 of the present invention includes a hemispherically-shaped, ball-like portion 16awhich is receivable in a socket-like portion 64 that is carried by an externally threaded connector head 66 to which the flexible neck 18 is interconnected. More particularly, threaded connector head 66 includes an outwardly extending shank portion 66awhich is received within a square aperture 64aformed in socket-like portion 64. A generally hemispherical-shaped spacer 68, which is interconnected with shank portion 66 by means of a screw 70 is closely received within ball-like portion 16aof mounting plate 16 in the manner illustrated in FIG. 4. An internally threaded connector ring 68 is threadably connected to connector head 66 to hold the various components of the connector means in the assembled configuration illustrated in FIG. 4 of the drawings. With the novel construction thus described, mounting plate 16 along with the article connector plate can be controllably revolved in a manner to position the plates within a plane that permits optimum viewing and operation of the particular object that is interconnected with the object connector plate. This unique positioning of the object connector plate 24 and the device supported thereby is not possible with prior art devices such as those exemplified in FIG. 1A of the drawings.

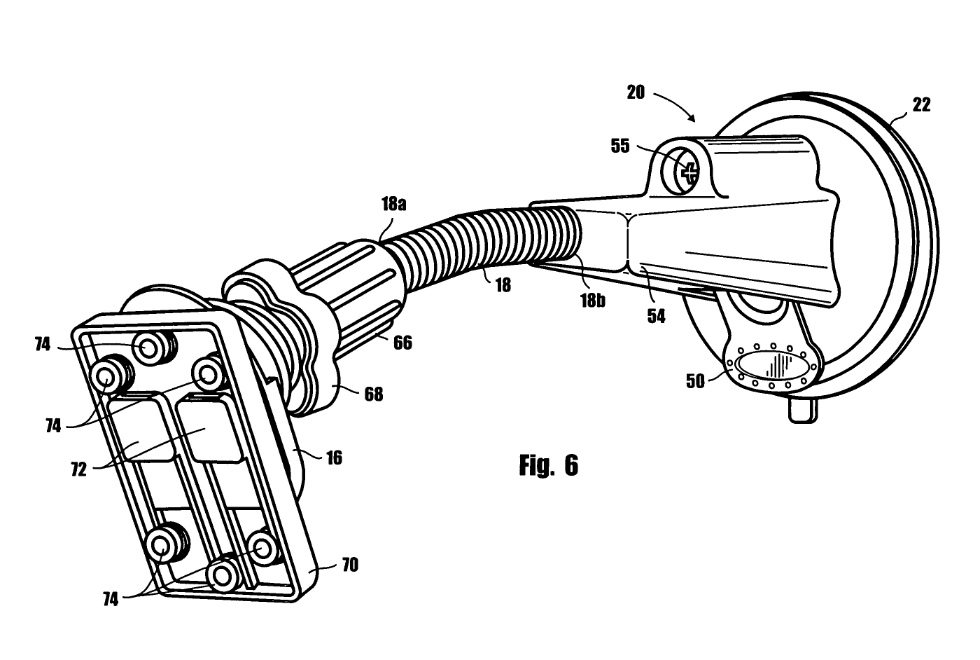

Turning to FIG. 6, an alternate form of object connector plate 70 is shown interconnected with the mounting structure of the character previously described. Object connector plate 70 is similar in construction to object connector plate 24, but is uniquely provided with connector cavities 72 that extend lengthwise of the plate rather than transversely. This construction permits differently configured devices to be interconnected with the object connector plate using the connector apertures 74.

Having now described the invention in detail in accordance with the requirements of the patent statutes, those skilled in this art will have no difficulty in making changes and modifications in the individual parts or their relative assembly in order to meet specific requirements or conditions. Such changes and modifications may be made without departing from the scope and spirit of the invention, as set forth in the following claims.

I Claim:

1. In a mounting structure for supporting objects within a vehicle comprising an elongated flexible arm having at one end a suction-type connection designed to be removably attached to a smooth surface and having at the other end an object mounting structure, the improvement comprising an improved object mounting structure including:
(a) a mounting plate;
(b) connector means for interconnecting said mounting plate with the elongated flexible arm;
(c) a pair of spaced-apart connector elements connected to said mounting plate; and
(d) a connector plate interconnected with said pair of spaced-apart connector elements.

2. The object mounting structure as defined in claim 1 in which said mounting plate has an upper planar surface and in which said pair of spaced-apart connector elements protrude outwardly from said surface.

3. The object mounting structure as defined in claim 2 in which said connector plate includes a pair of spaced-apart cavities and in which each of said pair of spaced-apart connector elements comprise a generally “T”-shaped segment that is lockably received within said cavities formed in said connector plate.

4. The mounting structure as defined in claim 3 in which said mounting plate includes a hemispherically-shaped, ball-like portion and in which said connector means includes a socket portion within which said the hemispherically-shaped ball-like portion is received.

5. A mounting structure for supporting objects within a vehicle comprising:
(a) an elongated flexible arm having first and second ends;
(b) a mounting plate connected to said first end of said elongated flexible arm, said mounting plate including a generally planar surface and a pair of transversely spaced-apart connector elements extending from said generally planar surface plate;
(c) connection means connected to said first end of said flexible arm for interconnecting said mounting plate with said flexible arm;
(d) a suction forming mechanism connected to said second end of said elongated flexible arm, said suction forming mechanism including:
(i) a suction cup for engagement with a smooth surface; and
(ii) a suction forming mechanism for causing a suction to be formed between said suction cup and said smooth surface, said suction forming mechanism comprising an inner housing having an axial chamber and a drive member reciprocally movable within said axial chamber, said drive member being interconnected with said suction cup; and
(e) an object connector plate interconnected with said mounting plate, said object connector plate having a pair of spaced-apart cavities constructed and arranged to mate with said pair of spaced-apart connector elements of said mounting plate.

6. The mounting structure as defined in claim 5 in which each of said pair of spaced-apart connectors of said mounting plate comprise a generally “T”-shaped segment that is lockably received within said cavities formed in said connector plate.

7. The mounting structure as defined in claim 5 in which said mounting plate includes a hemispherically-shaped, ball-like portion and in which said connector means includes a socket portion within which said the hemispherically-shaped ball-like portion is received.

8. The mounting structure as defined in claim 5 in which said suction forming mechanism further includes an outer housing, said inner housing of said suction forming mechanism being partially housed within said outer housing.

9. The mounting structure as defined in claim 5 in which said suction forming mechanism further includes a finger engaging, pivotally mounted lever member connected to said drive member for reciprocally moving said drive member within said axial chamber of said inner housing.

10. The mounting structure as defined in claim 5 in which said connection means, includes an externally threaded connector head having an outwardly extending shank portion.

11. A mounting structure for supporting objects within a vehicle comprising:
(a) an elongated flexible arm having first and second ends;
(b) a mounting plate connected to said first end of said elongated flexible arm, said mounting plate including a generally planar surface and a pair of transversely spaced-apart connectors extending from said generally planar surface of said mounting plate, each of said pair of spaced-apart connectors of said mounting plate comprising a generally “T”-shaped segment;
(c) connection means connected to said first end of said flexible arm for interconnecting said mounting plate with said flexible arm, said connection means including an externally threaded connector head having an outwardly extending shank portion;
(d) a suction forming mechanism connected to said second end of said elongated flexible arm, said suction forming mechanism including:
(i) a suction cup having an inner surface having a central portion and an outer surface for engagement with a smooth surface; and
(ii) a suction forming mechanism for causing a suction to be formed between said suction cup and said smooth surface, said suction forming mechanism comprising:
a. an inner housing having an axial passageway;
b. a drive member connected to said suction cup and reciprocally movable within said axial passageway;
c. a finger engaging, pivotally mounted lever member connected to said drive member for reciprocally moving said drive member within said axial passageway of said inner housing from a first retracted position to the second extended position; and
d. an outer housing partially enclosing said inner housing, said outer housing having a neck portion interconnected with said first end of said elongated flexible arm; and
(e) an object connector plate interconnected with said mounting plate, said object connector plate having a pair of spaced-apart cavities constructed and arranged to lockably receive said “T”-shaped segments of said pair of spaced-apart connectors of said mounting plate.

12. The mounting structure as defined in claim 11 in which said mounting plate includes a hemispherically-shaped, ball-like portion and in which said connector means includes a socket portion within which said the hemispherically-shaped ball-like portion is received.

13. The mounting structure as defined in claim 11 in which said connection means further includes an internally threaded connector ring threadably connected to said externally threaded connector head.

14. The mounting structure as defined in claim 11 in which said inner housing includes a concave cavity within which the central portion of said inner surface of said suction cup is received when said drive member is moved into said first retracted position.
